(19) United States
(12) Patent Application Publication
(10) Pub. No.: US 2011/0062201 A1
(43) Pub. Date: Mar. 17, 2011

(54) CUP HOLDER FOR A VEHICLE

(75) Inventor: Chang Min LEE, Whasung-Si (KR)

(73) Assignee: Hyundai Motor Company, Seoul (KR)

(21) Appl. No.: 12/717,708

(22) Filed: Mar. 4, 2010

(30) Foreign Application Priority Data
Sep. 11, 2009 (KR) 10-2009-0085643

(51) Int. Cl. B60R 11/00

(52) U.S. Cl. 224/567

(57) ABSTRACT

A cup holder for a vehicle may include a housing with an opening in an upper portion thereof, rail plates mounted on both sides of the housing, and a slide cover provided on the opening of the housing to open and close the cup holder by sliding back and forth along the rail plates, characterized in that the slide cover includes a plurality of shutter pieces, which are coupled with each other in a parallel direction, rail contact portions respectively formed at both side ends of each of the shutter pieces, and first protrusions, each of which is formed in a central side end of each of the rail contact portions.

### CROSS-REFERENCE TO RELATED APPLICATION

The present application claims priority to Korean Patent Application No. 10-2009-0085643, filed on Sep. 11, 2009, the entire contents of which is incorporated herein for all purposes by this reference.

### BACKGROUND OF THE INVENTION

1. Field of the Invention

The present invention relates to a cup holder for a vehicle, and more particularly to a cup holder for a vehicle having a slide cover mounted on an opening of a housing, wherein the slide cover has a plurality of rail contact portions with protrusions to slide back and forth along grooves in rail plates mounted on both sides of the housing, so that the protrusions formed on the rail contact portions can have a line contact with the grooves of the rail plates, thus facilitating the slide cover to move smoothly and operate with less friction.

2. Description of Related Art

Conventionally, there have been various forms of cup holders for a vehicle.

One example of conventional cup holders is the one with a slide cover. The slide cover is mounted on an opening of a housing of a cup holder and slides back and forth to open and close the cup holder. The slide cover comprises a thin sheet made of soft material and a plurality of protrusions attached to a surface of the thin sheet at a predetermined interval in a parallel direction. The slide cover hooks on a pair of guide rails provided at both side ends of the housing to slide along the guide rails.

When a cup is to be placed in the cup holder, the cup holder is opened by sliding the slide cover backward to an end of the opening of the housing. The slide cover moves along the guide rails provided in the opening portion of the housing, and moves further along extended guide rails, which are formed by extending the guide rails of the opening portion of the housing. Then, the slide cover is received in a receiving portion, which is formed at the rear end of the opening of the housing.

When the slide cover moves from the guide rails in the opening portion to the guide rails in the receiving portion, portions of the thin sheet of the slide cover, to which the protrusions are not attached, should bend smoothly, so that the slide cover can move smoothly through the guide rails.

On the other hand, when the cup holder is closed, the slide cover moves forward along the guide rails to reach the other end of the opening of the housing.

In the above conventional cup holder, the protrusions provided on the thin sheet of the slide cover are made of hard material to ensure the rigidity not to deform under a predetermined weight imposed on the slide cover in the above closed state of the cup holder.

However, in order to prevent the slide cover from being derailed from the guide rails, the protrusions are needed to have extensions to hook on the guide rails.

Further, as the protrusions were formed of hard material, it was necessary to ensure the stability of opening and closing operations of the slide cover and to reduce sliding noise.

FIGS. 1 and 2 show another conventional cup holder as disclosed in Korean Patent Publication No. 2002-20838 published on Mar. 16, 2002. The cup holder includes a slide cover 5 mounted on an opening of a housing 4. The slide cover 5 slides along guide rails 6 provided at both side ends of the opening. The slide cover 5 is received in a receiving portion 8, which is formed at the rear end of the opening of the housing 4.

The above cup holder is characterized in that a damping portion 12 is provided on at least one of both hook coupling portions 11 of the guide rails 6 and the slide cover 5, so as to allow the slide cover 5 to be displaced in a direction perpendicular to the sliding direction. In order to prevent the release of the damping portion 12, ribs 14 are formed in the guide rails 6.

The slide cover 5 comprises thick portions 9 and thin portions 10, which are alternately formed. Ribs 13 are provided to increase cross-sectional secondary moment in a direction perpendicular to the thick portions 9.

The damping portions 12 are made of elastic material and are provided at both side ends of the slide cover 5 made of flexible synthetic resin. The elastic damping portions 12 are in contact with the guide rails 6.

Since the damping portions 12 can be deformed during opening and closing operations of the slide cover 5, slide noise and rattling can be reduced, while the stability of opening and closing operations can be enhanced.

Further, when the slide cover 5 is bent, since the ribs 14 formed in the guide rails 6 can prevent the release of the damping portion 12, the release of the slide cover 5 can also be prevented.

However, the above conventional cup holder has a disadvantage that the structure of preventing the release of the damping portion 5 makes it difficult to assemble parts of the cup holder.

Also, the slide cover 5 does not operate smoothly since it is difficult to maintain an interval between the slide cover 5 and the ribs 14.

Further, since the coupling portions 11 make a face contact with the guide rails 6, frictional resistance increases, while operational performance of the slide cover 5 decreases. Durability of products may also deteriorate.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide to a cup holder for a vehicle having a slide cover mounted on an opening of a housing, wherein protrusions formed on the slide cover have a line contact with rail plates mounted on both sides of the housing, so that the slide cover can move smoothly and operate with less friction and to provide a cup holder for a vehicle, with increased easiness of assembly of parts of the slide cover, decreased manufacturing costs, increased operational performance of the slide cover, and increased durability.

In an aspect of the present invention, the cup holder for a vehicle may include a housing with an opening in an upper portion thereof, rail plates mounted on both sides of the housing, and a slide cover provided on the opening of the housing to open and close the cup holder by sliding back and forth along the rail plates, characterized in that the slide cover includes a plurality of shutter pieces, which are coupled with each other in a parallel direction, rail contact portions respectively formed at both side ends of each of the shutter pieces, and first protrusions, each of which is formed in a central side end of each of the rail contact portions.

The cup holder of the present invention may be characterized in that a shutter piece provided at a last end of the slide cover has second protrusions at rear ends of the rail contact portions formed at both side ends of the shutter piece.

In another aspect of the present invention, the cup holder for a vehicle may include a housing having an opening in an upper portion thereof, rail plates mounted on both lateral sides of the housing and including a rail groove, and a slide cover slidably coupled to the rail groove of the rail plates and configured to open and close the opening of the cup holder by sliding back and forth the slide cover along the rail groove of the rail plates, wherein the slide cover includes: a plurality of shutter pieces, which are flexibly coupled with each other in a parallel direction, rail contact portions respectively formed at both lateral side ends of each of the shutter pieces and slidably received in the rail groove of the rail plates, and first protrusions, each of which is formed in a lateral side end of each of the rail contact portions along a longitudinal axis of the shutter piece toward the rail groove.

The rail contact portions may be formed in arc-shape in a perpendicular direction to the longitudinal axis of the shutter piece.

the rail contact portions may be formed flat.

A shutter piece provided at a last end of the slide cover may have second protrusions at rear ends of the rail contact portions in a perpendicular direction of the first protrusion.

The second protrusion may be formed in arc-shape.

The first protrusion may be formed in arc-shape.

The slide cover of the present invention may be formed by TPE (thermoplastic elastomer) integral molding, which is processed by insert injection molding of TPE resin layer on ABS (acrylonitrile butadiene styrene copolymer) resin plate. The ABS resin can be easily processed and have great impact resistance and excellent heat resistance. The TPE resin layer is flexible and has excellent contact property.

According to an aspect of the present invention, the conventional structure for preventing the release of the damping portions is removed, and protrusions are provided at both side ends of the slide cover to have a line contact with rail plates mounted on both sides of the housing.

According to another aspect of the present invention, the slide cover has a simple structure, so that it can be easily manufactured by simple assembly of parts thereof. This can contribute to the reduction of manufacture costs.

Further, according to various aspects of the present invention, in the course of opening and closing operations of the cup holder, only the ends of the protrusions formed on the rail contact portions come into linear contact with the rail plates, so that friction between the slide cover and the rail plates can be reduced, thus facilitating the operation of the slide cover and enhancing the durability of the cup holder.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a partial longitudinal sectional view of a conventional cup holder for a vehicle.

FIG. 2 is a cross-sectional view along the line III-III of FIG. 1.

FIG. 3 is an exploded perspective view of an exemplary embodiment of the present invention.

FIG. 4 is a plane view of the exemplary embodiment of the present invention as shown in FIG. 3.

FIG. 5 is a partial longitudinal sectional view of the exemplary embodiment of the present invention as shown in FIG. 3.

FIG. 6 is a partial plane view of a slide cover according to the exemplary embodiment of the present invention as shown in FIG. 3.

FIG. 7 is a bottom view of the slide cover according to the exemplary embodiment of the present invention as shown in FIG. 3.

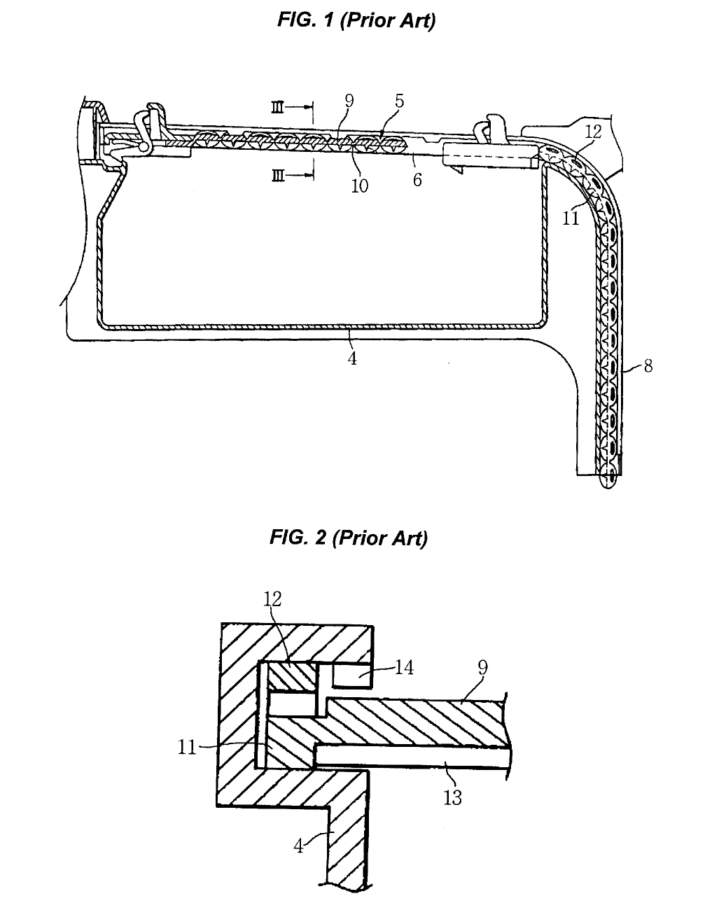

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

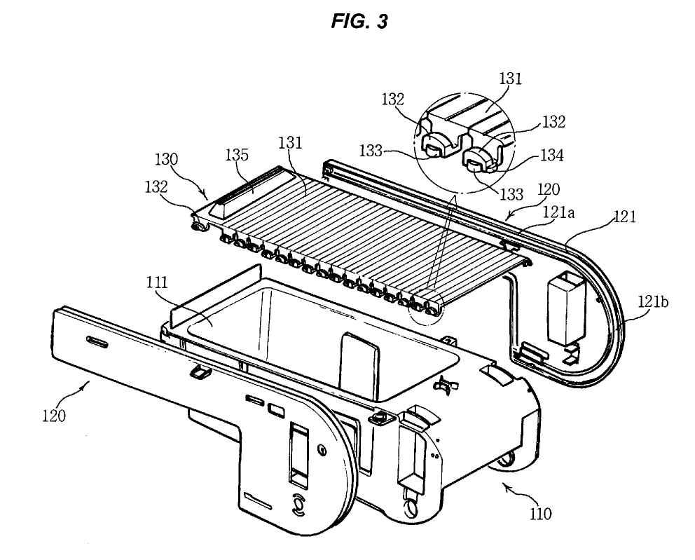

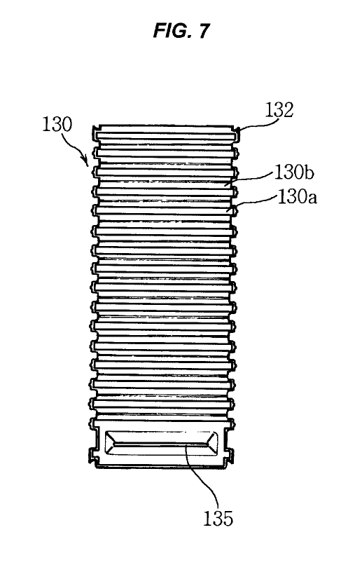

FIGS. 3 to 7 show an exemplary embodiment of the present invention.

A cup holder for a vehicle according to an exemplary embodiment of the present invention comprises: a housing 110 with an opening 111 on a top portion thereof; rail plates 120 mounted on both lateral sides of the housing 110; and a slide cover 130 provided on the opening 111 of the housing 110 to open and close the cup holder by sliding back and forth along the rail plates 120.

A pair of rail grooves 121 is formed along an internal surface of the rail plates 120 to support the movement of the slide cover 130. A rail groove 121 comprises a horizontal groove part 121a and an arc-shaped receiving portion 121b formed at a rear end of the horizontal groove part 121a.

The slide cover 130 comprises a plurality of shutter pieces 131, which are coupled with each other in a parallel direction.

Rail contact portions 132 are respectively formed at both side ends of each of the shutter pieces 131, and first protrusions 133 are respectively formed in a central side end of each of the rail contact portions 132.

The shutter piece 131 provided at the last end of the slide cover 130 includes second protrusions 134 respectively formed at rear ends of the rail contact portions 132, which are respectively formed at both side ends of the shutter piece 131.

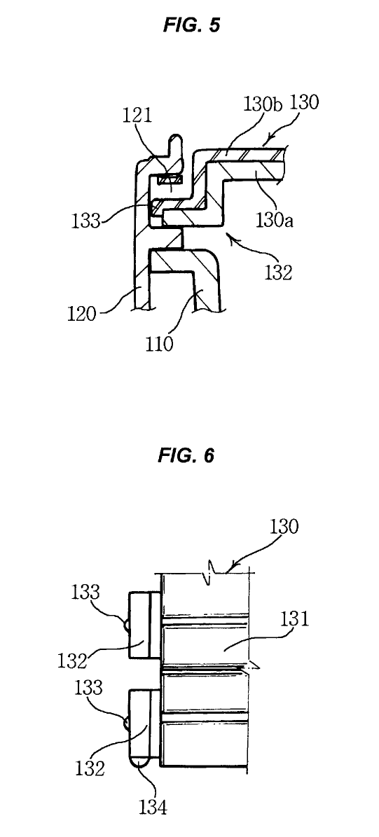

In an exemplary embodiment of the present invention as shown in FIG. 5, the slide cover 130 of the present invention may be formed by TPE integral molding, which is processed by insert injection molding of TPE resin layer 130b on ABS resin plate 130a. The ABS resin plate 130a can be easily processed and has high impact resistance and excellent heat resistance. The TPE resin layer 130b is flexible and has excellent contact property.

In the above exemplary embodiment of the present invention, the first protrusions 133 are described as being formed in an arc-shape. However, it will be recognizable to those skilled in the art that various modifications and variations can be made to the shape of the first protrusions 133. Furthermore, the rail contact protrusion 132, as an exemplary embodiment of the present invention, may be formed flat as shown in FIG. 5.

The reference numeral 135 represents a handle, which is provided on top surface of the slide cover 130 to facilitate the opening and closing operations of the slide cover 130.

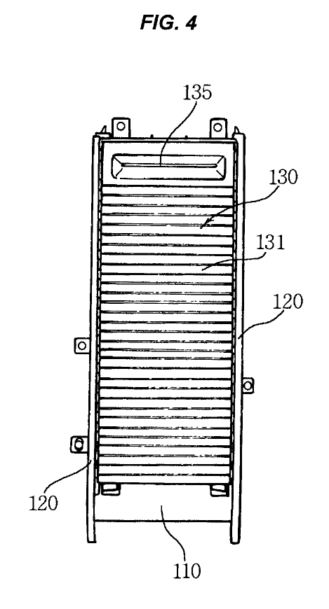

FIGS. 3 and 4 show the handle 135 mounted at a front end of the top surface of the slide cover 130.

When the opening 111 of the housing 110 of the cup holder is to be opened, the handle 135 is pulled rearward and the rail contact portions 132 provided at both side ends of the shutter pieces 131 of the slide cover 130 move along the rail grooves 121 of the rail plates 120, until they are received in the arc-shaped receiving portions 121b of the rail grooves 121.

On the other hand, when the opening 111 of the housing 110 of the cup holder is to be closed, the handle 135 is pulled forward. The rail contact portions 132, which have been received in the receiving portions 121b, move towards the horizontal groove parts 121a of the rail grooves 121, until the slide cover 130 is horizontally unfolded and covers the opening 111 of the housing 110.

According to various aspects of the present invention, the structure of the slide cover 130 is so simple that the slide cover 130 can be easily manufactured and assembled.

Further, in the course of opening and closing operations of the cup holder, since only the ends of the first protrusions 133 formed on the rail contact portions 132 come into a line contact with the rail grooves 121 of the rail plates 120, friction between the slide cover 130 and the rail plates 120 can be remarkably reduced, thus facilitating the operation of the slide cover 130 and enhancing the durability of the cup holder.

For convenience in explanation and accurate definition in the appended claims, the terms “upper” and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cup holder for a vehicle comprising:
a housing with an opening in an upper portion thereof;
rail plates mounted on both sides of the housing; and
a slide cover provided on the opening of the housing to open and close the cup holder by sliding back and forth along the rail plates,
characterized in that the slide cover comprises a plurality of shutter pieces, which are coupled with each other in a parallel direction; rail contact portions respectively formed at both side ends of each of the shutter pieces; and first protrusions, each of which is formed in a central side end of each of the rail contact portions.

2. The cup holder for a vehicle as claimed in claim 1, characterized in that a shutter piece provided at a last end of the slide cover has second protrusions at rear ends of the rail contact portions formed at both side ends of the shutter piece.

3. The cup holder for a vehicle as claimed in claim 1, characterized in that the slide cover is formed by insert injection molding of TPE resin layer on ABS resin plate.

4. The cup holder for a vehicle as claimed in claim 2, characterized in that the slide cover is formed by insert injection molding of TPE resin layer on ABS resin plate.

5. A cup holder for a vehicle comprising:
a housing having an opening in an upper portion thereof;
rail plates mounted on both lateral sides of the housing and including a rail groove; and
a slide cover slidably coupled to the rail groove of the rail plates and configured to open and close the opening of the cup holder by sliding back and forth the slide cover along the rail groove of the rail plates,
wherein the slide cover includes:
a plurality of shutter pieces, which are flexibly coupled with each other in a parallel direction;
rail contact portions respectively formed at both lateral side ends of each of the shutter pieces and slidably received in the rail groove of the rail plates; and
first protrusions, each of which is formed in a lateral side end of each of the rail contact portions along a longitudinal axis of the shutter piece toward the rail groove.

6. The cup holder for a vehicle as claimed in claim 5, wherein the rail contact portions is formed in arc-shape in a perpendicular direction to the longitudinal axis of the shutter piece.

7. The cup holder for a vehicle as claimed in claim 5, wherein the rail contact portions is formed flat.

8. The cup holder for a vehicle as claimed in claim 5, wherein a shutter piece provided at a last end of the slide cover has second protrusions at rear ends of the rail contact portions in a perpendicular direction of the first protrusion.

9. The cup holder for a vehicle as claimed in claim 8, wherein the second protrusion is formed in arc-shape.

10. The cup holder for a vehicle as claimed in claim 5, wherein the slide cover is formed by insert injection molding of TPE resin layer on ABS resin plate.

11. The cup holder for a vehicle as claimed in claim 5, wherein the first protrusion is formed in arc-shape.
